(19) United States
(12) Patent Application Publication
(10) Pub. No.: US 2026/0307860 A1
(43) Pub. Date: Oct. 8, 2026

(54) STORAGE BOX AND STORAGE SYSTEM

(71) Applicant: HANGZHOU GREAT STAR INDUSTRIAL CO., LTD., Hangzhou (CN)

(72) Inventor: Yueming LI, Hangzhou (CN)

(21) Appl. No.: 19/672,803

(22) Filed: May 11, 2026

(30) Foreign Application Priority Data
Apr. 29, 2026 (CN) 202610589940.1

(51) Int. Cl. B65D 25/22; B65D 43/16

(52) U.S. Cl. CPC B65D 25/22; B65D 43/163

(57) ABSTRACT

A storage box and a storage system are provided. The storage box includes a box body, and the box body is provided with a storage space. A wall plate of the box body facing an external mounting surface is defined as a first wall plate, and the first wall plate is provided with a mounting portion configured to suspend the box body on the external mounting surface.

### CROSS-REFERENCE TO RELATED APPLICATION

This application claims priority to Chinese patent application No. 202610589940.1, filed on Apr. 29, 2026, and titled “STORAGE BOX AND STORAGE SYSTEM”. The content of the above identified application is hereby incorporated herein in its entirety by reference.

### TECHNICAL FIELD

The present disclosure relates to the technical field of storage tools, and in particular, to a storage box and a storage system.

### BACKGROUND

A storage box is used to store miscellaneous items or a specific category of items centrally, such that space can be organized and utilized effectively, while also providing protective functions such as dust resistance and moisture resistance. The storage box serves as a common storage tool in various scenarios including homes, offices and warehouses.

In related or conventional technologies, the storage box is often placed directly on the floor or on a desktop, which not only occupies valuable floor or counter space, thereby reducing space utilization, but also results in a relatively low placement position regardless of whether it is placed on a floor or a desktop. As a result, a user needs to bend down frequently to retrieve an object, which, over time, maycause lumbar strain. This is particularly problematic for small-sized apartments, as it can also affect the activity area within the room, aggravating the sense of crowding and confinement.

### SUMMARY

According to various embodiments of the present disclosure, a storage box and a storage system are provided.

The present disclosure provides a storage box. The storage box includes a box body provided with a storage space. A wall plate of the box body facing an external mounting surface is defined as a first wall plate, and the first wall plate is provided with a mounting portion configured to suspend the box body on the external mounting surface.

The present disclosure provides a storage system. The storage system includes the storage box as described in any of the above embodiments and an external mounting surface. The storage box is provided with a bottom surface, and a height of the bottom surface from the ground along a vertical direction is in a range of 900 mm to 2200 mm.

Details of one or more embodiments of the present disclosure are presented in the attached drawings and descriptions below. Other features, purposes, and advantages of the present disclosure will become apparent from the description, drawings, and claims.

### BRIEF DESCRIPTION OF THE DRAWINGS

For a better description and illustration of embodiments and/or examples of the inventions disclosed herein, reference may be made to one or more accompanying drawings. Additional details or examples used to describe the drawings should not be considered as limiting the scope of any of the disclosed inventions, the presently described embodiments and/or examples, and the best mode of these inventions as presently understood.

FIG. 1 is a perspective view of a storage box according to an embodiment.

FIG. 2 is a perspective view of the storage box of FIG. 1 from another angle.

FIG. 3 is a schematic cross-sectional view of the storage box of FIG. 1.

FIG. 4 is a partial enlarged view of a portion A of the storage box of FIG. 3.

FIG. 5 is a schematic structural view of a portion of a storage box corresponding to that shown in FIG. 4 according to another embodiment.

FIG. 6 is a perspective view of a storage box according to another embodiment.

FIG. 7 is a schematic cross-sectional view of the storage box of FIG. 6.

FIG. 8 is a perspective view of a storage box according to another embodiment, shown in a connected state with a second mounting member.

FIG. 9 is a schematic view of the storage box and the second mounting member of FIG. 8 in an exploded state.

FIG. 10 is a perspective view of a storage box according to another embodiment, shown in a connected state with a second mounting member.

FIG. 11 is a schematic cross-sectional view of the storage box of FIG. 10.

FIG. 12 is a partial enlarged view of a portion B of the storage box of FIG. 11.

FIG. 13 is a schematic view of the storage box and the second mounting member of FIG. 10 in an exploded state.

FIG. 14 is a perspective view of a storage box according to another embodiment.

FIG. 15 is a schematic view of the storage box of FIG. 14 connected with an external mounting surface.

FIG. 16 is a partial enlarged view of a portion C of FIG. 15.

FIG. 17 is a perspective view of the storage box and an external mounting plate of FIG. 15 from another angle.

FIG. 18 is a partial enlarged view of a portion D of FIG. 17.

FIG. 19 is a perspective view of the storage box and an external mounting plate of FIG. 15 from another angle.

Reference signs are as below.

10 represents a storage box; 101 represents a storage space; 102 represents a mounting portion; 103 represents an opening; 104 represents a bottom surface; 110 represents a box body; 111 represents a first sidewall; 1111 represents a through hole; 1112 represents a first hole portion; 1113 represents a second hole portion; 1114 represents a flange; 1115 represents a reinforcing rib; 120 represents a connecting member; 130 represents a first mounting member; 131 represents a first hanging plate; 132 represents a bent plate; 1301 represents an insertion slot; 1302 represents a sliding groove; 133 represents a second hanging plate; 1331 represents a notch portion; 1332 represents an abutting portion; 134 represents an extension portion; 135 represents a connecting plate; 140 represents a locking member; 141 represents a locking portion; 150 represents an abutting member; 160 represents a lid; 170 represents a door; 180 represents a drawer assembly; 190 represents a partition plate; 20 represents an external mounting surface; 210 represents a second mounting member; 211 represents a support plate; 212 represents a mounting plate; 213 represents an engaging portion; and 201 represents a hanging slot.

### DETAILED DESCRIPTION

The present disclosure provides a storage box, which includes a box body 110. The box body 110 is provided with a storage space 101. A wall plate of the box body 110 facing an external mounting surface 20 is defined as a first wall plate 111. The first wall plate 111 is provided with a mounting portion 102 configured to suspend the box body 110 on the external mounting surface 20.

The present disclosure includes the following advantages: the box body 110 of the storage box 10 can be suspended and mounted on the external mounting surface 20. Compared with being stacked and placed on the floor or on a desktop, the box body 110 is mounted at a relatively high position. Thus, a user can adjust a mounting height of the box body 110 freely, which not only improves the ease of use of the box body 10 by avoiding frequent bending when using, but also increases utilization of vertical space and optimizes spatial layout, allowing the same amount of space to accommodate more articles. In addition, since the box body 110 may not be placed on the floor or desktop, space on the floor and desktop is freed up, making the space neater and more aesthetically pleasing.

Illustratively, the external mounting surface 20 may be a wall surface, a surface of a modular cabinet, or a panel mounted on a wall, such as a pegboard panel mounted on a wall.

Illustratively, the box body 110 may be made of iron or plastic, which is not limited in the present disclosure, as long as the box body 110 can be connected to the external mounting surface 20 via the mounting portion 102.

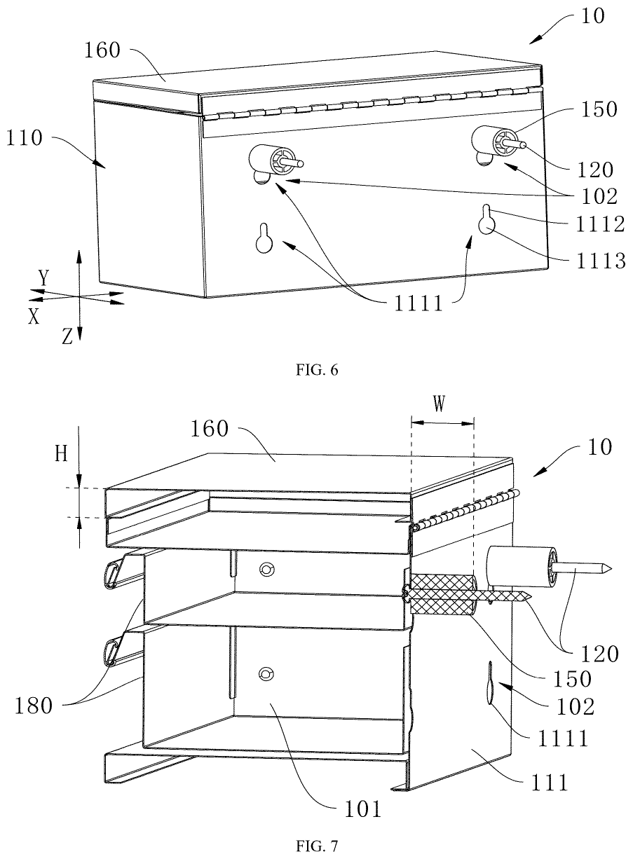

In an embodiment, referring to FIG. 2, FIG. 6, and FIG. 7, the mounting portion 102 may be a through hole 1111 formed in the first wall plate 111. The through hole 1111 may be configured for allowing a connecting member 120 to pass through to be fixedly connected to the external mounting surface 20. In this way, the case 110 can be suspended on the external mounting surface 20 in a relatively simple manner, and the manufacturing cost of the mounting portion 102 is relatively low.

Illustratively, taking the connecting member 120 as a screw as an example: when mounting the box body 110, the screw may pass through the through hole 1111 and be fixed to the external mounting surface 20, thereby suspending the box body 110 on the external mounting surface 20. In this embodiment, the external mounting surface 20 may be provided with a clearance hole for allowing insertion of the screw. In other embodiments, the connecting member 120 may also be a hook fixed to the external mounting surface 20. In this case, the through hole 1111 can be directly fitted over an outer periphery of the hook, such that the box body 110 can be hung on the external mounting surface 20.

Illustratively, the through hole 1111 may be an arcuate hole, a polygonal hole, an irregularly shaped hole, or the like, which is not limited in the present disclosure, as long as the through hole 1111 can be cooperated and connected to the connecting member 120.

In an embodiment, a height direction Z of the box body 110 may be defined as a top-to-bottom direction. Referring to FIG. 5, FIG. 6, and FIG. 7, the through hole 1111 may include a first hole portion 1112 and a second hole portion 1113 sequentially in communication with each other from top to bottom. Along a length direction X of the box body 110, an aperture of the first hole portion 1112 may be smaller than that of the second hole portion 1113. That is, the through hole 1111 may be a keyhole-shaped hole. It can be understood that an outer diameter of the connecting member 120 may be smaller than the aperture of the first hole portion 1112. The mounting of the box body 110, where the through hole 1111 is fitted over the outer periphery of the connecting member 120, is taken as an example for explanation. Firstly, the second hole portion 1113 may be fitted over the outer periphery of the connecting member 120. Then, the box body 110 may be moved downward relative to the connecting member 120, allowing the connecting member 120 to enter the first hole portion 1112. In this way, the first hole portion 1112 having the relatively small aperture can achieve a limiting function relative to the connecting member 120, i.e., the first hole portion 1112 may be configured to limit the box body 110, thereby preventing the box body 110 from shaking relative to the external mounting surface 20 and making the mounting of the box body 110 more stable.

It should be noted that “the aperture of the first hole portion 1112” may refer to a maximum inner diameter of the first hole portion 1112 along the length direction X of the box body 110, and “the aperture of the second hole portion 1113” may refer to a maximum inner diameter of the second hole portion 1113 along the length direction X of the box body 110. The first hole portion 1112 and the second hole portion 1113 are not limited to partial circular holes, and may also be elliptical holes or holes in other forms.

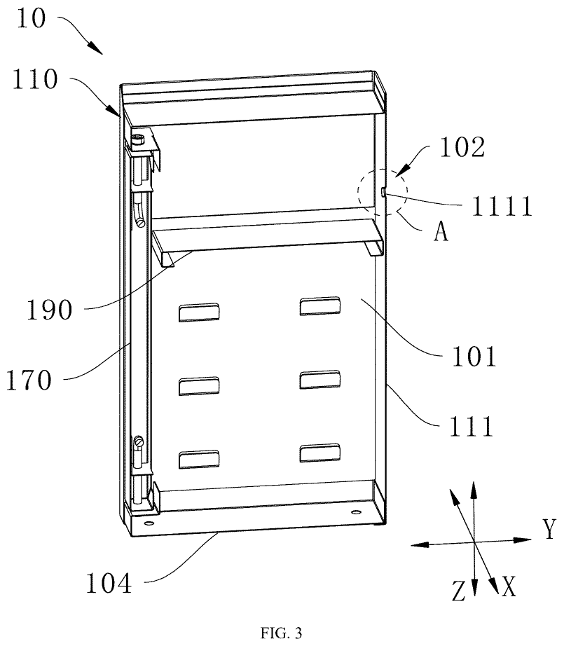

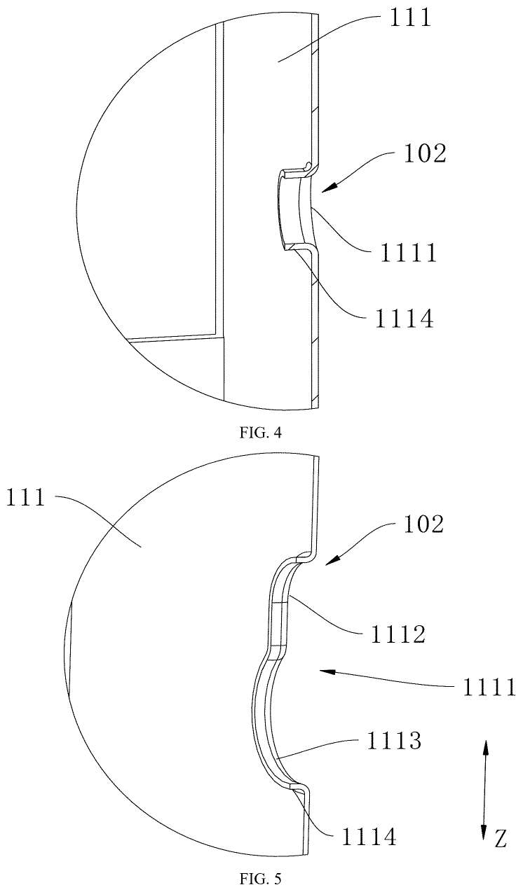

In an embodiment, referring to FIG. 3, FIG. 4, and FIG. 5, a periphery of the through hole 1111 may be bent toward the storage space 101 or away from the storage space 101 to form a flange 1114. Th expression “the periphery of the through hole 1111 may be bent toward the storage space 101” may mean that the flange 1114 is located inside the storage space 101, and the expression “the periphery of the through hole 1111 may be bent away from the storage space 101” may mean that the flange 1114 is located outside the storage space 101. That is, the flange 1114 may be located either inside or outside the storage space 101. It can be understood that when the box body 110 is mounted on the external mounting surface 20 through the cooperation between the through hole 1111 and the connecting member 120, the through hole 1111 may be a stress concentration point of the entire storage box 10. In this embodiment, the flange 1114 is provided at the peripheral edge of the through hole 1111, such that the strength of the through hole 1111 can be increased, and deformation or cracking at the through hole 1111 is prevented, thereby preventing the box body 110 from falling off the mounting location, and thus prolonging the service life and improving safety of the storage box 10.

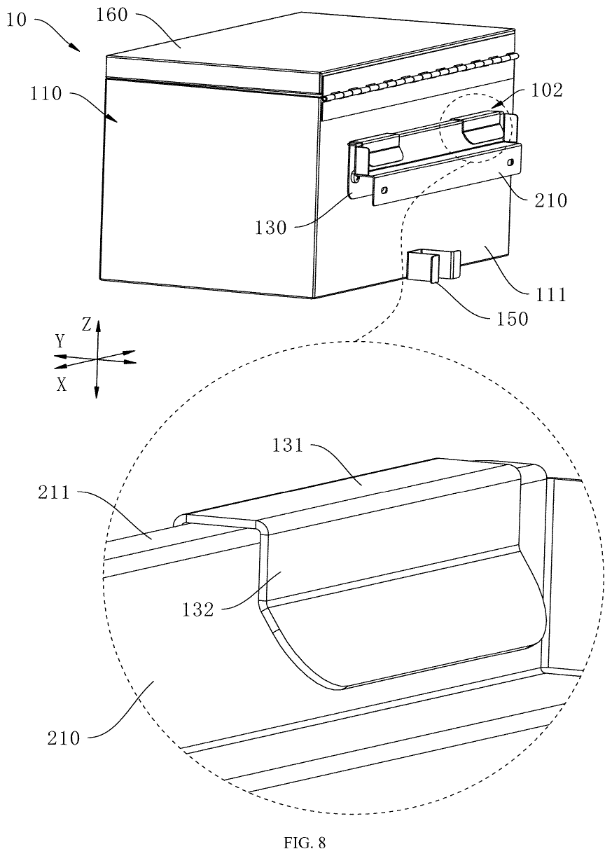

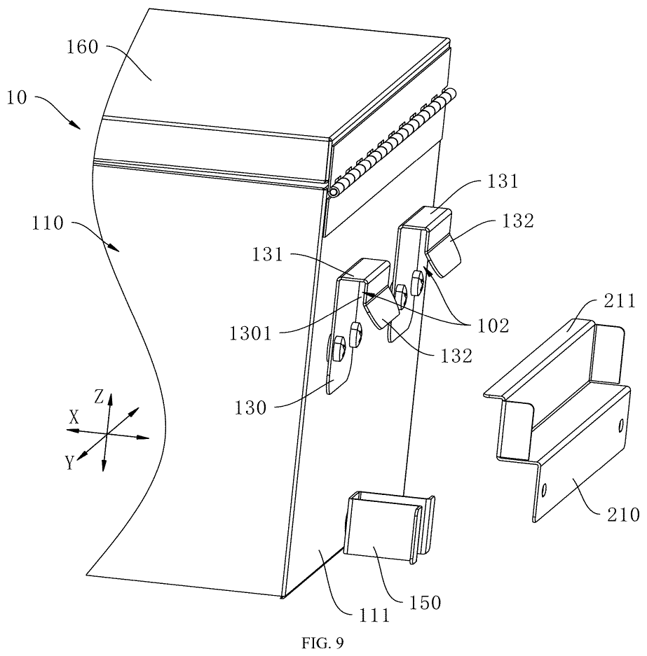

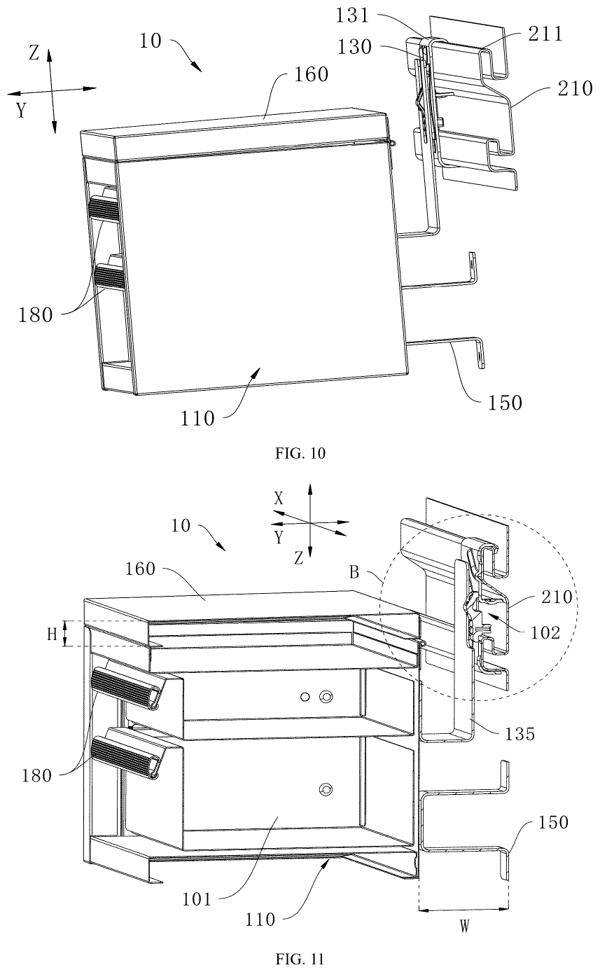

In an embodiment, referring to FIG. 8 to FIG. 12, the first wall plate 111 may be fixedly connected to a first mounting member 130, and the mounting portion 102 may be formed on a side of the first mounting member 130 adjacent to the external mounting surface 20. The external mounting surface 20 may be provided with a second mounting member 210, and the mounting portion 102 may be connectable to the second mounting member 210. That is, after the first mounting member 130 and the second mounting member 210 are engaged, the box body 110 is suspended on the external mounting surface 20, thereby completing the mounting process of the box body 110. Thus, the entire mounting process is very simple, without performing excessive positioning, connecting, and fixing operations for the storage box 10. In addition, under the condition that the second mounting member 210 is fixed to the external mounting surface 20, it is only necessary to engage the first mounting member 130 with the second mounting member 210 directly during subsequent mounting of the box body 110, without adjusting the mounting position and angle of the box body 110 repeatedly. It can be understood that adjusting the fixed position of the second mounting member 210 is far less difficult than directly adjusting the mounting position of the box body 110, thereby further simplifying the mounting process of the box body 110.

Illustratively, the first mounting member 130 may be a hook connected to a side of the first wall plate 111 away from the storage space 101. A hooked portion of the hook may be used as the mounting portion 102 of the box body 110. The external mounting surface 20 may be provided with a cooperating structure such as a rail or a pegboard that can be engaged with the hook. Alternatively, the hook may be fixedly connected to the first wall plate 111 by welding, stamping, screw fixing, or the like.

In an embodiment, referring to FIG. 8 to FIG. 12, the mounting portion 102 may include a first hanging plate 131 extending along a thickness direction Y of the first wall plate 111, and the second mounting member 210 may be provided with a support plate 211 configured to support the first hanging plate 131. The installation between the box body 110 and the external mounting surface 20 is completed by simply laying the first hanging plate 131 on the support plate 211. Thus, the mounting process of the box body 110 is simple and easy to operate.

Illustratively, both the first hanging plate 131 and the support plate 211 may be horizontally arranged flat plates. The first hanging plate 131 can be directly laided on the support plate 211. A plurality of first hanging plates 131 may be provided to increase the supporting stability of the box body 110 by the support plate 211. As shown in FIG. 9, in this embodiment, two first hanging plates 131 may be provided, and the two hanging plates may be spaced apart along the length direction X of the box body 110. In other embodiments, more than two first hanging plates 131 may be provided, and the plurality of first hanging plates 131 may also be arranged along other directions.

In an embodiment, the first hanging plate 131 may also be gradually away from the first wall plate 111 along the top-to-bottom direction, that is, the first hanging plate 131 is obliquely arranged toward the external mounting surface 20 along the top-to-bottom direction. The support plate 211 may be vertically arranged or obliquely arranged to match the first hanging plate 131. In this way, the supporting effect of the support plate 211 on the first hanging plate 131 is more secure. In addition, in the mounting process of the box body 110, the obliquely arranged first hanging plate 131 can be configured to guide the mounting, reducing the positioning accuracy requirement for the box body 110 during the mounting, thereby making the mounting process of the box body 110 faster.

In an embodiment, referring to FIG. 8 and FIG. 9, the first hanging plate 131 may be connected to the first mounting member 130, and an end portion of the first hanging plate 131 away from the first mounting member 130 may be provided with a bent plate 132 bent downward. An insertion slot 1301 may be formed between the first mounting member 130, the first hanging plate 131, and the bent plate 132, and a bottom of the insertion slot 1301 may be provided with an insertion opening configured to allow the support plate 211 to enter and exit. The mounting process of the box body 110 is explained below by taking FIG. 9 as an example: in the height direction Z of the box body 110 (corresponding to the top-to-bottom direction in FIG. 9), the insertion opening is positioned above the support plate 211. After aligning the insertion opening with the support plate 211, the box body 110 may be moved from top to bottom, such that the insertion slot 1301 can be fitted over the support plate 211. At this time, the support plate 211 and the insertion slot 1301 may abut against each other, and the support plate 211 can support the insertion slot 1301. Thus, the mounting portion 102 and the second mounting member 210 can be connected together by plugging-in, thereby suspending and mounting the box body 110 on the external mounting surface 20. In addition, the first mounting member 130, the first hanging plate 131, and the bent plate 132 may form an inverted U-shaped insertion slot 1301, and the support plate 211 can be enclosed within the insertion slot 1301. In this way, the insertion slot 1301 and the support plate 211 may be mutually limited, which can further increase the firmness and stability of the connection between the insertion slot 1301 and the support plate 211.

Illustratively, the first mounting member 130, the first hanging plate 131, and the bending plate 132 may be integrally formed, or may be separately formed and then connected together.

It should be noted that one end of the support plate 211 is connected to the external mounting surface 20, a gap is reserved between the end of the support plate 211 adjacent to the first wall plate 111 and the external mounting surface 20. When the mounting portion 102 and the second mounting member 210 are in a connected state, at least a portion of the bent plate 132 is accommodated within the gap. In other embodiments, a slot may also be formed in the second mounting member 210, and when the mounting portion 102 and the second mounting member 210 are in a connected state, the insertion slot 1301 can be engaged with the slot.

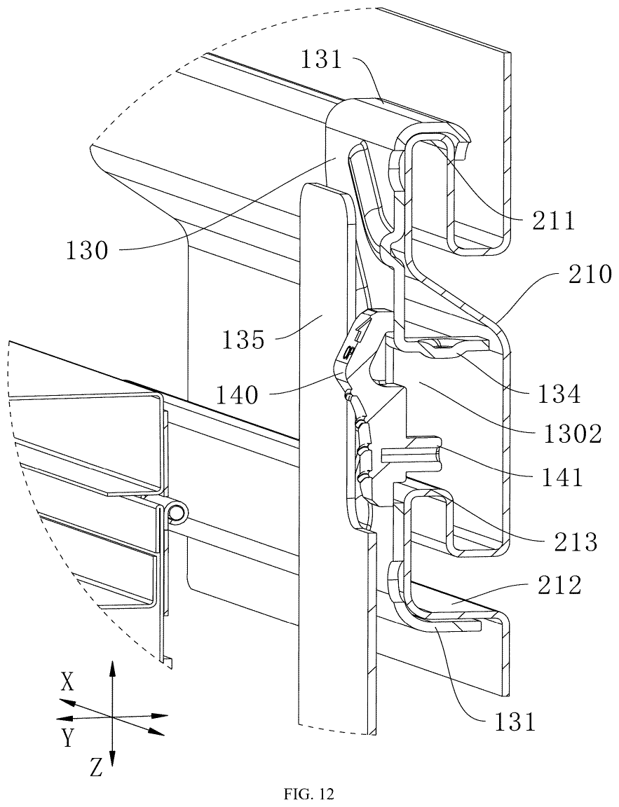

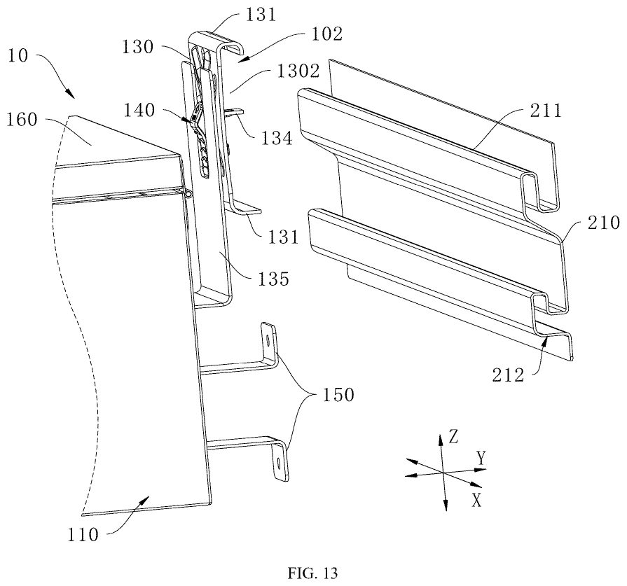

In an embodiment, referring to FIG. 10, FIG. 11, FIG. 12, and FIG. 13, the first hanging plate 131 may be connected to the first mounting member 130, and two first hanging plates 131 may be provided. The two first hanging plates 131 may be spaced apart from each other along the height direction Z of the box body 110. A sliding groove 1302 may be defined between the two first hanging plates 131 and the first mounting member 130. At least one side of the sliding groove 1302 arranged along the length direction X of the box body 110 may be provided with an opening configured to allow the support plate 211 to enter and exit, and the sliding groove 1302 may be slidable relative to the support plate 211. That is, the sliding groove 1302 may be a C-shaped groove facing the external mounting surface 20. The second mounting member 210 may be further provided with a mounting plate 212. The mounting plate 212 and the support plate 211 may be arranged spaced apart from each other along the height direction Z of the box body 110. When the sliding groove 1302 is in a state of being mounted on the second mounting member 210, at least a portion of the mounting plate 212 and at least a portion of the support plate 211 may both be located within the sliding groove 1302, and the mounting plate 212 and the support plate 211 may be engaged with the first hanging plates 131 on corresponding sides, respectively. The mounting plate 212 provides a stopping and limiting function for the sliding groove 1302. It can be understood that, after the box body 110 is suspended and mounted on the external mounting surface, the gravity of the box body 110 and the gravity of articles stored in the storage space 101 may cause the box body 110 to have a tendency to rotate rearward and downward about connection points between the support plate 211 and the first hanging plates 131 on the corresponding sides. When the mounting plate 212 abuts against a corresponding inner wall surface of the sliding groove 1302, the rotation tendency can be effectively resisted, thereby limiting rearward rotation of the box body 110, preventing the box body 110 from shaking during mounting and use, and thus greatly enhancing the stability of the box body 110 mounted on the external mounting surface 20.

In addition, the sliding groove 1302 may be slidably connected to the mounting plate 212, allowing the position of the box body 110 on the second mounting member 210 to be easily changed, thereby making the arrangement of the storage box 10 more flexible. The mounting process of the box body 110 will be explained below by taking FIG. 13 as an example: in the length direction X of the box body 110 (corresponding to the left-right direction in FIG. 13), the opening of the sliding groove 1302 may be positioned beside the support plate 211, and after the insertion opening is aligned with the support plate 211, the box body 110 may be moved from left to right (or from right to left), the sliding groove 1302 can be fitted over the support plate 211 and the mounting plate 212. At this time, the support plate 211 and the mounting plate 212 may be engaged with corresponding sidewalls of the sliding groove 1302, respectively. Thus, the mounting portion 102 and the second mounting member 210 can be connected together by plugging-in, thereby suspending and mounting the box body 110 on the external mounting surface 20.

Illustratively, the first mounting member 130 and the two first hanging plates 131 may be integrally formed. In this case, the sliding groove 1302 may be formed by bending two opposite edges of the first mounting member 130 in the height direction Z of the box body 110 toward each other, respectively, so as to increase the overall strength of the first mounting member 130. In other embodiments, the first hanging plates 131 may also be fixed to the first mounting member 130 by welding, threaded connection, screw connection, or the like.

In one embodiment, the first mounting member 130 may be provided with a locking member 140, and the locking member 140 may be arranged to have a locked state in which the first mounting member 130 is fixed to the second mounting member 210 and an unlocked state in which the first mounting member 130 is detachable from the second mounting member 210. Thus, when the mounting portion 102 and the second mounting member 210 are in the connected state, i.e., the box body 110 is mounted on the external mounting surface 20 via the mounting portion 102 and the second mounting member 210, and the locking member 140 is in the locked state, the locking member 140 can prevent the box body 110 from moving relative to the external mounting surface 20, thereby enabling the box body 110 to be more stably connected to the second mounting member 210.

Illustratively, the locking member 140 may be a connecting rod capable of sequentially passing through the first mounting member 130 and the second mounting member 210. Two ends of the connecting rod along its axial direction are sleeved with limiting members, respectively. Along the axial direction of the connecting rod, both of the first mounting member 130 and the second mounting member 210 may be located between the two limiting members. In this way, the first mounting member 130 can be locked onto the second mounting member 210 by the two limiting members and the connecting rod. Also illustratively, the locking member 140 may be a clamp capable of locking the first mounting member 130 and the second mounting member 210 together. The specific structure of the locking member 140 is not limited in the present disclosure, as long as the locking member 140 can lock the first mounting member 130 onto the second mounting member 210 and can also unlock the first mounting member 130 from the second mounting member 210.

In an embodiment, a side of the locking member 140 facing the external mounting surface 20 may be provided with a locking portion 141, and the second mounting member 210 may be provided with an engaging portion 213 configured to be engaged with the locking portion 141. When the mounting portion 102 is connected to the second mounting member 210, the locking portion 141 and the engaging portion 213 may both be located in the sliding groove 1302, and when the locking member 140 is in the locked state, the locking portion 141 may abut against the engaging portion 213 to restrict sliding of the mounting portion 102 relative to the support plate 211. It can be understood that the first mounting member 130 can be unlocked from the second mounting member 210 by operating the locking member 140 to make the locking portion 141 away from the engaging portion 213, and at this time, the position of the box body 110 relative to the second mounting member 210 can be changed.

Illustratively, referring to FIG. 11 and FIG. 12, the locking member 140 may be moved along the top-to-bottom direction in FIG. 11 and FIG. 12. The locking portion 141 may be driven by the locking member 140 to move upward, thereby separating the locking portion 141 from the engaging portion 213, and the locking member 140 may be in the unlocked state at this time. In this embodiment, the first mounting member 130 may be further provided with an extension portion 134 extending from the first mounting member 130 toward the external mounting surface 20. The extension portion 134 may be located above the locking portion 141. The locking member 140 may further include an elastic member (not shown) vertically disposed between the extension portion 134 and the locking portion 141. Two ends of the elastic member may act on the extension portion 134 and the locking portion 141 respectively, such that the locking portion 141 always has a tendency to abut tightly against the engaging portion 213. In other embodiments, the locking member 140 may also be rotatably connected to the first mounting member 130, with the locking portion 141 being adaptively modified accordingly.

Illustratively, referring to FIG. 10 to FIG. 13, the first mounting member 130 may be connected to the first wall plate 111 via a connecting plate 135 to increase a spacing between the first mounting member 130 and the first wall plate 111, thereby providing space for the arrangement and operation of the locking member 140.

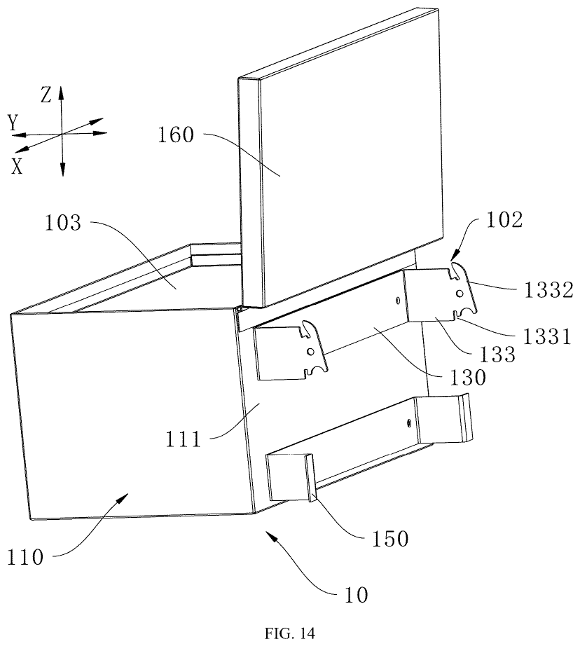

In an embodiment, referring to FIG. 14 to FIG. 19, the first wall plate 111 may be fixedly connected to a vertically arranged second hanging plate 133. The second hanging plate 133 may extend along the thickness direction Y of the first wall plate 111. The mounting portion 102 may be configured as a notch portion 1331 provided on an upper edge and/or a lower edge of the second hanging plate 133. The external mounting surface 20 may be provided with a hanging slot 201 configured to allow the second hanging plate 133 to enter and exit along the thickness direction Y of the first wall plate 111. When the second hanging plate 133 is connected to the external mounting surface 20, the notch portion 1331 may be configured to be engaged with a corresponding slot wall of the hanging slot 201, and an end of the second hanging plate 133 away from the first wall plate 111 may abut against a side of the external mounting surface 20 away from the first wall plate 111.

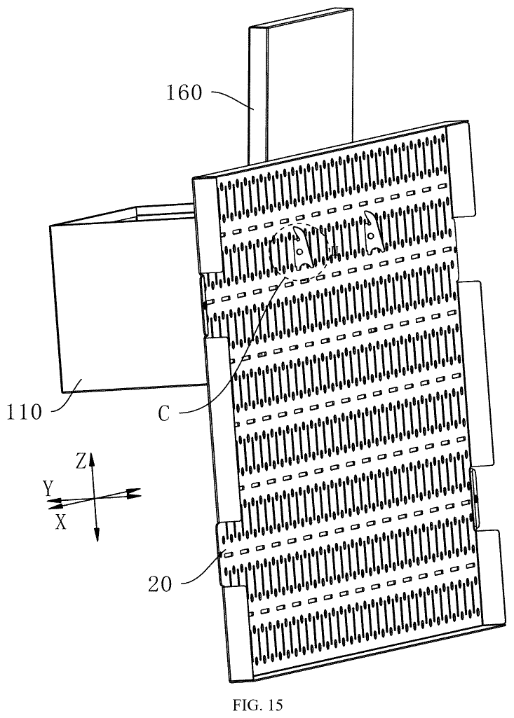

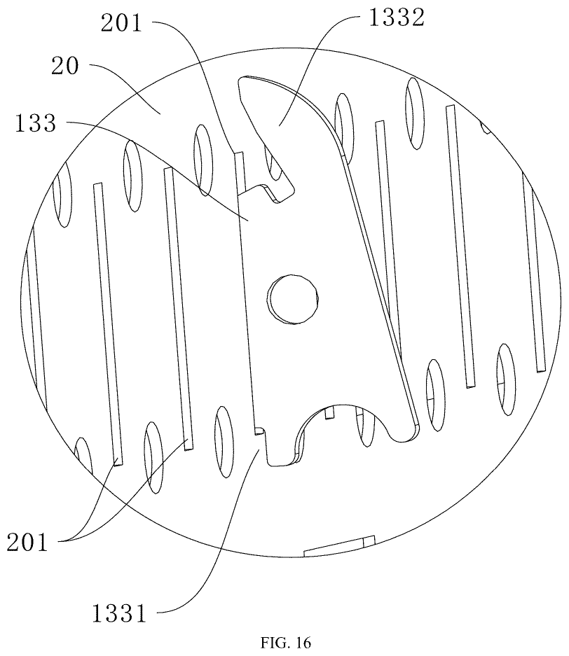

Specifically, referring to FIG. 15 and FIG. 16, the second hanging plate 133 may include an abutting portion 1332. The abutting portion 1332 may be located on a side of the notch portion 1331 away from the first wall plate 111. When the first mounting member 130 is connected to the external mounting surface 20, the abutting portion 1332 may abut against the external mounting surface 20 to prevent the second hanging plate 133 from detaching from the hanging slot 201. In this embodiment, the external mounting surface 20 may be a pegboard provided with a plurality of hanging slots 201. The notch portion 1331 of the box body 110 may be inserted into any of the hanging slots 201 as required, thereby improving the positional flexibility of the box body 110.

Specifically, the upper and lower edges of the second hanging plate 133 may be correspondingly provided with notch portions 1331. A dimension of the hanging slot 201 along the height direction Z of the box body 110 may be slightly smaller than that of the second hanging plate 133, and a dimension of each of the two notch portions 1331 along the height direction Z of the box body 110 may be slightly smaller than that of the hanging slot 201. Thus, the second hanging plate 133 can be mounted into the hanging slot 201. It should be noted that during the mounting process of the second hanging plate 133 and the hanging slot 201, it is necessary to engage the notch portion 1331 with the hanging slot 201 at a certain inclination angle.

In an embodiment, referring to FIG. 2, the first wall plate 111 may be provided with a reinforcing rib 1115 to increase the strength of the first wall plate 111, thereby preventing deformation or cracking of the first wall plate 111 and thus prolonging the service life of the box body 110.

Illustratively, the reinforcing rib 1115 may be disposed on a wall surface of the first wall plate 111 facing or away from the storage space 101. The reinforcing rib 1115 may extend along the length direction X of the box body 110 or along the height direction Z of the box body 110, as long as the reinforcing rib 1115 can increase the strength of the first wall plate 111.

In an embodiment, the reinforcing rib 1115 may be formed by a portion of the first wall plate 111 protruding toward the storage space 101 or away from the storage space 101. That is, the reinforcing rib 1115 may be integrally formed on the first wall plate 111, such that the strength of the first wall plate 111 can be better improved.

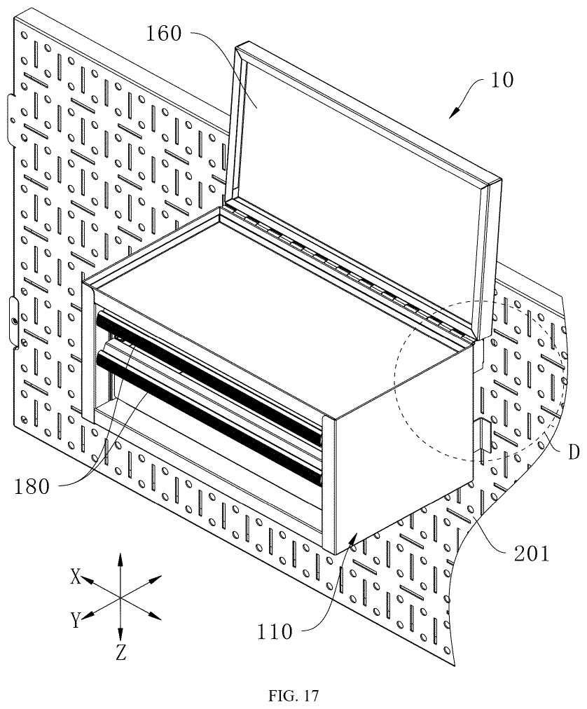

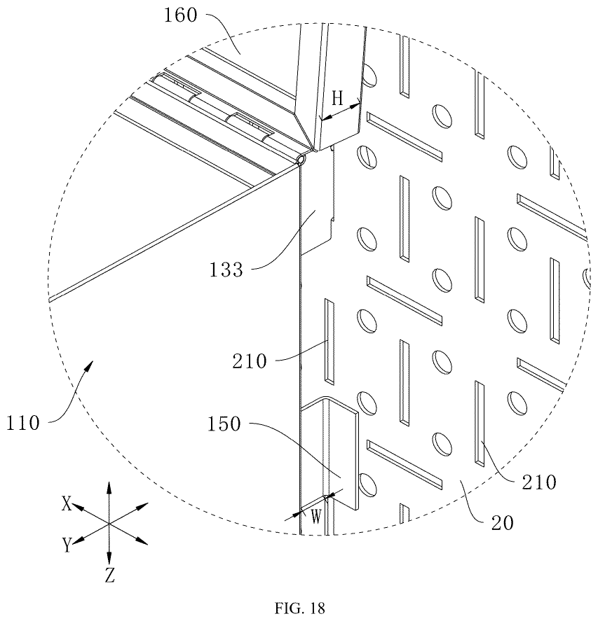

It can be understood that an opening 103 configured for allowing articles to enter and exit may be provided on a side of the storage space 101. In an embodiment, referring to FIG. 14 and FIG. 17, the opening 103 may be provided at a top of the storage space 101. The storage box 10 may further include a lid 160 connected to the box body 110 to open or close the opening 103. By providing the lid 160 to cover the opening 103, not only dust, insects, etc., can be prevented from entering the storage space 101, thereby protecting objects stored in the storage space 101, but also the lid 160 can be used to hide objects located in the storage space 101, such that the space where the storage box 10 is mounted neater and more aesthetically pleasing.

Illustratively, the lid 160 may be directly laid on the top of the box body 110 to close the opening 103, and the opening 103 can be opened by directly removing the lid 160. The lid 160 may also be rotatably connected to a wall plate of the box body 110, and a rotation axis of the lid 160 may be along the thickness direction Y of the box body 110 or along the length direction X of the box body 110, which is not limited in the present disclosure, as long as the lid 160 can open or close the opening 103.

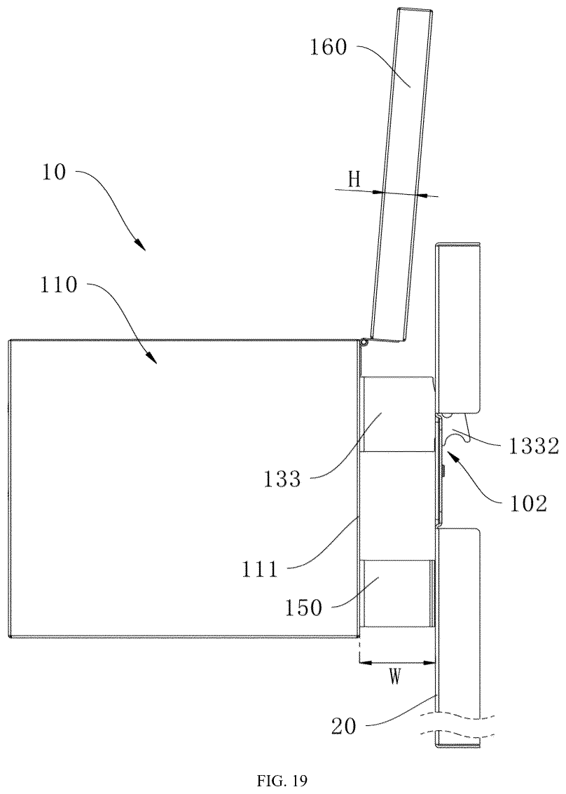

In an embodiment, referring to FIG. 7, FIG. 11, FIG. 14, FIG. 17, FIG. 18, and FIG. 19, the lid 160 may be rotatably connected to the first wall plate 111. That is, when the box body 110 is connected to the external mounting surface 20, the lid 160 may rotate in a direction toward the external mounting surface 20 to open the opening 103, and the lid 160 may rotate in a direction away from the external mounting surface 20 to open the opening 103. A distance between the first wall plate 111 and the external mounting surface 20 may be denoted as W. When the opening 103 is closed by the lid 160, a height of the lid 160 may be denoted as H. The distance W between the first wall plate 111 and the external mounting surface 20 and the height H of the lid 160 may satisfy the following relationship: 8 mm≤(W−H)≤25 mm. Thus, when the lid 160 is rotated to open the opening 103, the wall surface can be prevented from interfering with the lid 160, such that the lid 160 can be opened smoothly. It should be noted that (W−H) may refer to a difference obtained by subtracting the height H of the lid 160 from the distance W between the first wall plate 111 and the external mounting surface 20. It should be further noted that, FIG. 7 and FIG. 11 show the lid 160 in a closed state covering the opening 103, while FIG. 18 and FIG. 19 show the lid 160 in an open state exposing the opening 103.

Alternatively, a difference of (W−H) may have a value of 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, or any other value in a range of 8 mm≤(W−H)≤25 mm.

In some embodiments, referring to FIG. 6, FIG. 7, FIG. 8, FIG. 10, FIG. 11, FIG. 14, FIG. 17, and FIG. 18, a side of the first wall plate 111 adjacent to the external mounting surface 20 may be provided with an abutting member 150, and when the box body 110 is suspended on the external mounting surface 20, the abutting member 150 may abut against the external mounting surface 20. That is, the abutting member 150 may be located outside the storage space 101. It can be understood that the dimension of the abutting member 150 along the thickness direction Y of the first wall plate 111 may be the distance W between the first wall plate 111 and the external mounting surface 20. Thus, the value of the distance W between the first wall plate 111 and the external mounting surface 20 can be accurately controlled by using the abutting member 150.

Illustratively, taking FIG. 6 and FIG. 7 as an example, the mounting portion 102 may be a through hole 1111, and the box body 110 may be connected to the external mounting surface 20 via the connecting member 120 extending along the thickness direction Y of the first wall plate 111. In this case, the abutting member 150 may be a spacer block sleeved over the outer periphery of the connecting member 120. Since a portion of the connecting member 120 is inserted into the reserved hole of the external mounting surface 20, and the two opposite ends of the abutting member 150 along the axial direction of the abutting member 150 may abut against the first wall plate 111 and the external mounting surface 20, the dimension of the abutting member 150 along the thickness direction Y of the first wall plate 111 may be the distance W between the first wall plate 111 and the external mounting surface 20. For example, when the lid 160 has a height of 15 mm, the abutting member 150 may have a dimension of 30 mm along the thickness direction Y of the first wall plate 111; when the lid 160 has a height of 25 mm, the abutting member 150 may have a dimension of 42 mm along the thickness direction Y of the first wall plate 111; and when the lid 160 has a height of 32 mm, the abutting member 150 may have a dimension of 50 mm along the thickness direction Y of the first wall plate 111. Taking FIG. 8 and FIG. 10 as an example, the mounting portion 102 may be configured as a hanging plate provided on the first mounting member 130. In this case, the abutting member 150 may be fixedly connected to the first wall plate 111, and the abutting member 150 and the hanging plate may be spaced apart from each other along the top-to-bottom direction.

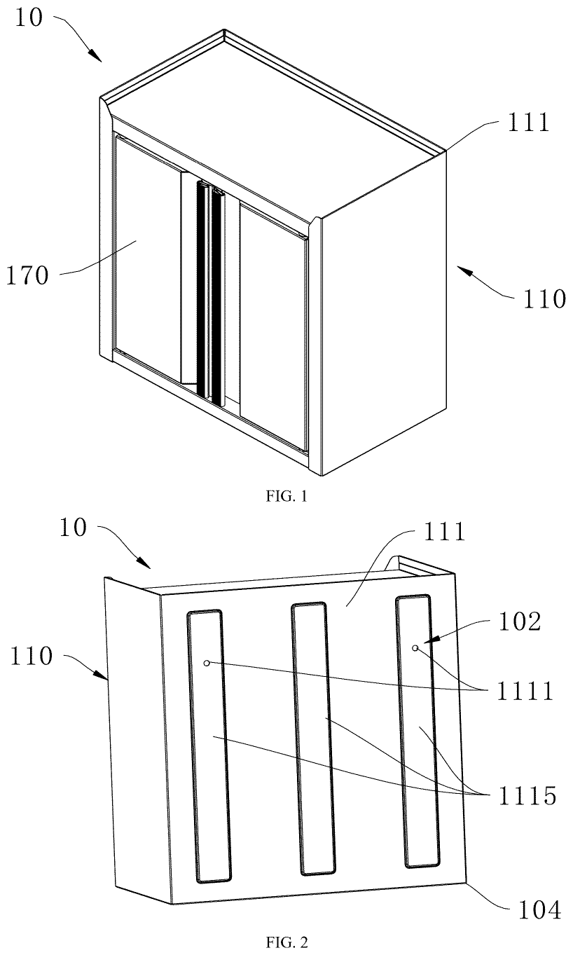

In another embodiment, the opening 103 may be provided on a side surface of the box body 110. Taking FIG. 1 and FIG. 3 as an example, the opening 103 and the first wall plate 111 may be arranged opposite and spaced apart. The storage box 10 may further include a door 170 configured to open or close the opening 103. The door 170 may be rotatably connected to the box body 110, and a rotation axis of the door 170 may be arranged along the top-to-bottom direction. For the storage box 10 mounted at a relatively high position, the opening 103 can be opened or closed more conveniently by using the rotatable door 170.

In an embodiment, the storage box 10 may have a length in a range of 200 mm to 400 mm, a thickness in a range of 120 mm to 300 mm, and a height in a range of 100 mm to 450 mm. Thus, the storage box 10 may be available in a variety of specifications, allowing a user to select a storage box 10 of an appropriate size as required, thereby improving the universality of the storage box 10.

Alternatively, the storage box may have a length of 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, or any other value in a range of 200 mm to 400 mm. Alternatively, the storage box 10 may have a thickness of 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, or any other value in a range of 120 mm to 300 mm. Alternatively, the storage box 10 may have a height of 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 40 mm, 430 mm, 440 mm, 450 mm or any other value in the range of 100 mm to 450 mm. The users can customize the length, thickness, and height of the storage box 10 as required, thereby improving the design flexibility of the storage box 10.

It should be noted that the thickness of the storage box 10 may refer to the dimension along the thickness direction Y of the first wall plate 111.

In an embodiment, a drawer assembly 180 may be disposed within the storage space 101, as shown in FIG. 7 and FIG. 11. Alternatively, a partition plate 190 may be provided within the storage space 101, as shown in FIG. 3, to further utilize the longitudinal space within the storage space 101.

The present disclosure may further provide a storage system, including the storage box 10 according to any of the above embodiments and an external mounting surface 20. The storage box 10 may be mounted on the external mounting surface 20 via the mounting portion 102 described above. The storage box 10 may be provided with a bottom surface 104, and a height of the bottom surface 104 from the ground along a vertical direction may be in a range of 900 mm to 2200 mm. Thus, the storage system can be adapted to operating habits of people of different heights, significantly improving the use convenience and comfort of the storage system. Specifically, the lower limit (900 mm) of the height range may be higher than typical reachable range of children, and the storage box may be suitable for storing items that should be kept away from children, such as medicines and scissors. Meanwhile, the upper limit (2200 mm) of the height range ensures that most adults can easily access and retrieve items without the need for a ladder, avoiding the risk of climbing and the risk of items falling due to being placed too high.

Illustratively, the height of the bottom surface 104 from the ground along the vertical direction may be 900 mm, 1000 mm, 1100 mm, 1200 mm, 1300 mm, 1400 mm, 1500 mm, 1600 mm, 1700 mm, 1800 mm, 1900 mm, 2000 mm, or any other value in the range of 900 mm to 2200 mm. For example, in the storage system, the height of the bottom surface of the storage box from the ground may be 36 inches (i.e., 914 mm). Alternatively, the height of the bottom surface of the storage box from the ground may be 84 inches (i.e., 2134 mm).

The various technical features of the embodiments described above can be combined arbitrarily. For brevity of description, not all possible combinations of the technical features in the above embodiments have been described. However, these combinations of technical features should be construed as falling within the scope of the specification as long as no contradiction occurs.

The above embodiments described above only represent several implementations of the present disclosure. The description thereof is relatively specific and detailed, but should not be construed as limiting the scope of the present disclosure. It should be noted that, for those skilled in the art, several modifications and improvements may be made without departing from the concept of the present disclosure, which all fall within the protection scope of the present disclosure. Therefore, the protection scope of the present disclosure shall be defined by the appended claims.

What is claimed is:

1. A storage box, comprising a box body, wherein the box body is provided with a storage space; and
a wall plate of the box body facing an external mounting surface is defined as a first wall plate, and the first wall plate is provided with a mounting portion configured to suspend the box body on the external mounting surface.

2. The storage box of claim 1, wherein the mounting portion is a through hole formed in the first wall plate, and the through hole is configured for allowing a connecting member to pass through to be fixedly connected to the external mounting surface.

3. The storage box of claim 2, wherein a height direction of the box body is defined as a top-to-bottom direction, the through hole comprises a first hole portion and a second hole portion sequentially in communication with each other from top to bottom, and along a length direction of the box body, an aperture of the first hole portion is smaller than that of the second hole portion.

4. The storage box of claim 2, wherein a periphery of the through hole is bent toward the storage space or away from the storage space to form a flange.

5. The storage box of claim 1, wherein the first wall plate is fixedly connected to a first mounting member, the mounting portion is formed on a side of the first mounting member adjacent to the external mounting surface, the external mounting surface is provided with a second mounting member, and the mounting portion is connectable to the second mounting member.

6. The storage box of claim 5, wherein the mounting portion comprises a first hanging plate extending along a thickness direction of the first wall plate, and the second mounting member is provided with a support plate configured to support the first hanging plate.

7. The storage box of claim 6, wherein the first hanging plate is connected to the first mounting member, an end portion of the first hanging plate away from the first mounting member is provided with a bent plate bent downward, an insertion slot is formed between the first mounting member, the first hanging plate, and the bent plate, and a bottom of the insertion slot is provided with an insertion opening configured to allow the support plate to enter and exit.

8. The storage box of claim 6, wherein the first hanging plate is connected to the first mounting member, two first hanging plates are provided, the two first hanging plates are spaced apart from each other along a height direction of the box body, a sliding groove is defined between the two first hanging plates and the first mounting member, at least one side of the sliding groove arranged along a length direction of the box body is provided with an opening configured for allowing the support plate to enter and exit, and the sliding groove is slidable relative to the support plate; and
the second mounting member is further provided with a mounting plate, the mounting plate and the support plate are spaced apart from each other along the height direction of the box body, in a state where the sliding groove is mounted to the second mounting member, at least part of the mounting plate and at least part of the support plate are both located in the sliding groove, and the mounting plate and the support plate are engaged with the two first hanging plates on corresponding sides, respectively.

9. The storage box of claim 8, wherein the first mounting member is provided with a locking member, and the locking member is arranged to have a locked state in which the mounting portion is fixed to the second mounting member and an unlocked state in which the mounting portion is detachable from the second mounting member.

10. The storage box of claim 9, wherein a side of the locking member facing the external mounting surface is provided with a locking portion, the second mounting member is provided with an engaging portion configured to be engaged with the locking portion, when the mounting portion is connected to the second mounting member, the locking portion and the engaging portion are both located in the sliding groove, and when the locking member is in the locked state, the locking portion abuts against the engaging portion to restrict sliding of the mounting portion relative to the support plate.

11. The storage box of claim 1, wherein the first wall plate is fixedly connected with a vertically arranged second hanging plate, the second hanging plate extends along a thickness direction of the first wall plate, and the mounting portion is configured as a notch portion provided on an upper edge and/or a lower edge of the second hanging plate; and
the external mounting surface is provided with a hanging slot configured to allow the second hanging plate to enter and exit along the thickness direction of the first wall plate; when the second hanging plate is connected to the external mounting surface, the notch portion is configured to be engaged with a corresponding slot wall of the hanging slot, and an end of the second hanging plate away from the first wall plate abuts against a side of the external mounting surface away from the first wall plate.

12. The storage box of claim 1, wherein the first wall plate is provided with a reinforcing rib.

13. The storage box of claim 12, wherein the reinforcing rib is formed by a portion of the first wall plate protruding toward the storage space or away from the storage space.

14. The storage box of claim 1, wherein a top of the storage space is configured as an opening, and the storage box further comprises a lid connected to the box body to open or close the opening.

15. The storage box of claim 14, wherein the lid is rotatably connected to the first wall plate;
when the box body is connected to the external mounting surface, a distance between the first wall plate and the external mounting surface is denoted as W, and when the opening is closed by the lid, a height of the lid is denoted as H, the distance W between the first wall plate and the external mounting surface and the height H of the lid satisfy the following relationship: 8 mm≤(W−H)≤25 mm.

16. The storage box of claim 15, wherein a side of the first wall plate adjacent to the external mounting surface is provided with an abutting member, and when the box body is suspended on the external mounting surface, the abutting member abuts against the external mounting surface.

17. The storage box of claim 16, wherein the storage box has a length in a range of 200 mm to 400 mm, a thickness in a range of 120 mm to 300 mm, and a height in a range of 100 mm to 450 mm.

18. A storage system, comprising an external mounting surface and a storage box mounted on the external mounting surface, wherein the storage box is provided with a bottom surface, and a height of the bottom surface from the ground along a vertical direction is in a range of 900 mm to 2200 mm.
